(19) United States
(12) Patent Application Publication
(10) Pub. No.: US 2022/0089361 A1
(43) Pub. Date: Mar. 24, 2022

(54) TEMPERATURE CONTROLLED CONAINER

(71) Applicant: Sunwell Engineering Company Limited, Woodbridge (CA)

(72) Inventor: Vladimir Goldstein, Woodbridge (CA)

(21) Appl. No.: 17/542,879

(22) Filed: Dec. 6, 2021

Related U.S. Application Data
(63) Continuation of application No. 15/516,307, filed on Mar. 31, 2017.
(60) Provisional application No. 62/059,360, filed on Oct. 3, 2014.

(51) Int. Cl. B65D 88/74; B65D 90/06; B65D 81/38

(52) U.S. Cl. CPC B65D 88/744; B65D 88/747; B65D 88/745; B65D 90/004; B65D 81/3813; B65D 2590/0075; B65D 90/06

(57) ABSTRACT

A temperature controlled container comprises exterior wall structure, interior wall structure positioned within the exterior wall structure, the interior wall structure at least partially defining an interior space configured to hold one or more products for shipping, and a chamber defined between the interior and exterior wall structure, the chamber configured to retain thermal storage medium to provide a thermally insulative layer at least partially protecting the interior space.

### FIELD

The subject application relates to containers and in particular to a temperature controlled container.

### BACKGROUND

It is common to ship products over vast distances by ground, sea and/or air transportation. In many instances, the products being shipped are placed in containers. When the products are not temperature-sensitive, there is typically no need to provide the containers with temperature control systems. When the products are temperature-sensitive, it is necessary to provide the containers with temperature control systems so that the internal temperature of the containers can be controlled thereby to avoid product spoiling due to low or high temperatures. As a result, refrigerated or heated containers are often used to maintain a substantially uniform and constant temperature throughout the interior of the containers in order to avoid spoilage. Many designs for temperature controlled containers have been considered.

For example, U.S. Patent Application Publication No. 2009/0293524 to Vezina et al. discloses a method and apparatus for protecting temperature sensitive products during air, ground, or sea transportation. Specific embodiments relate to a chamber built inside a trailer or sea container where temperature sensitive products are placed to have additional protection against the environmental conditions encountered during the transportation and distribution periods. The dimensions and modularity of the chamber can vary depending on the trailer or sea container the chamber is designed to be used with. The chamber can be preassembled and inserted into the desired trailer or sea container or can be assembled inside the trailer or sea container. The chamber can include insulated and or non-insulated walls, a conveyor system, a ventilation system and temperature and asset (trailer or sea container) location tracking. The location tracking can utilize, for example, cellular (GSM) and/or satellite communication, with or without GPS tracking. Each wall of the chamber can be composed of a single material or a combination of dissimilar materials. One or more of the materials in the wall can possess insulating and/or phase changing properties. Different layers of the wall may incorporate different materials.

U.S. Pat. No. 4,422,305 to Grosskopf discloses a cold storage element containing an eutectic brine cooled to a given freezing point by one or more refrigerant-conducting pipelines, the element being arranged interiorly of the body structure of a refrigerating vehicle. The cold storage element comprises a plastics material shell which has a rectangular configuration and a longitudinal rib interconnecting the opposing sidewalls. The pipeline for the refrigerant passes in a hair-pin configuration through both an upper compartment and a lower compartment defined by the longitudinal rib. Mounting assemblies and air control slats for the cold storage element are also provided.

Although temperature controlled containers have been considered, improvements are desired. It is therefore an object to provide a novel temperature controlled container.

### SUMMARY

Accordingly, in one aspect there is provided a temperature controlled container, comprising exterior wall structure, interior wall structure positioned within the exterior wall structure, the interior wall structure at least partially defining an interior space configured to hold one or more products for shipping, and a chamber defined between the interior and exterior wall structure, the chamber configured to retain thermal storage medium to provide a thermally insulative layer at least partially protecting the interior space.

In an embodiment the thermal storage medium is held in a confined space within the chamber. The confined space at least partially extends throughout the chamber. In an embodiment, the thermal storage medium is a cooling medium in the form of ice slurry. In another embodiment, the thermal storage medium is a heating medium in the form of glycol.

According to another aspect there is provided a method of retro-fitting a conventional container having exterior wall structure, the method comprising installing interior wall structure within the conventional container, the interior wall structure positioned such that at least a portion of the interior wall structure is in a generally parallel-spaced relationship with at least a portion of the exterior wall structure, thereby defining a chamber, and at least partially filling the chamber with thermal storage medium.

### BRIEF DESCRIPTION OF THE DRAWINGS

Embodiments will now be described more fully with reference to the accompanying drawings in which:

FIG. 1 is an isometric view of a temperature controlled container;

FIG. 2 is a cross-sectional view of the temperature controlled container of FIG. 2;

FIG. 3 is a rear view of the temperature controlled container of FIG. 1;

FIG. 4 is a rear view of another embodiment of a temperature controlled container;

FIG. 5 is a cross-sectional view of another embodiment of a temperature controlled container;

FIGS. 6A and 6B are rear and cross-sectional views, respectively, of another embodiment of a temperature controlled container; and

FIG. 7 is an isometric view of another embodiment of a temperature controlled container.

### DETAILED DESCRIPTION OF THE EMBODIMENTS

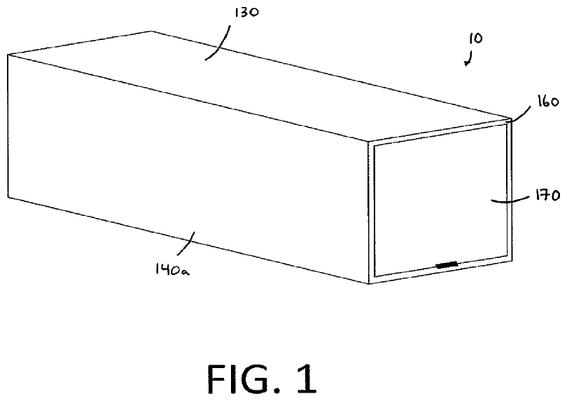

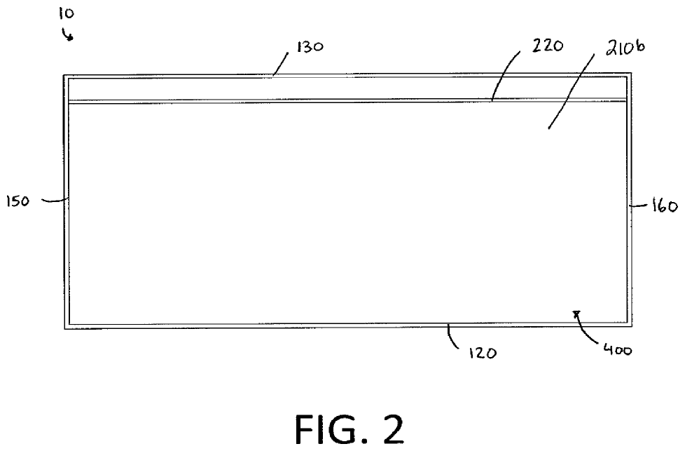

Turning now to FIGS. 1 to 3 a temperature controlled container is shown and is generally identified by reference numeral 10. The container 10 is used to ship one or more temperature sensitive products by ground, sea and/or air transportation. For example, to ship products by ground transportation, the container 10 is configured to be placed on a semi-trailer. To ship products by sea transportation, the container 10 is configured to be placed on a cargo ship. To ship products by air transportation, the container 10 is configured to be placed on a cargo airplane.

The container 10 comprises exterior wall structure 100 and interior wall structure 200 positioned within the exterior wall structure 100. A space between the exterior wall structure 100 and interior wall structure 200 defines a chamber 300 for holding a thermal storage medium. A drainage member 350 is coupled to the chamber and is configured to permit the egress of thermal storage medium from the chamber 300. An interior space 400 for holding one or more temperature sensitive products is defined by the interior wall structure 200.

The exterior wall structure 100 comprises a floor 120, a ceiling 130 and two spaced apart side walls 140a and 140b extending between a front wall 150 and a rear wall 160. The rear wall 160 comprises a door 170 such as for example a swing-type trailer door or a roll-type trailer door.

The interior wall structure 200 is made of a rigid material and is positioned within the exterior wall structure 100. In this embodiment, the interior wall structure 200 comprises side walls 210a and 210b and a top wall 220. Each of the side walls 210a and 210b is positioned in a substantially parallel-spaced relationship with respect to a respective side wall 140a and 140b of the exterior wall structure 100. The top wall 220 extends between the side walls 210a and 210b and is positioned in a substantially parallel-spaced relationship with respect to the ceiling 130 of the exterior wall structure 100.

The chamber 300 is defined between the ceiling 130 and side walls 140a, 140b of the exterior wall structure 100 and the top wall 220 and side walls 210a, 210b of the interior wall structure 200, respectively.

The draining member 350 is positioned at the bottom of the chamber 300. In this embodiment, the draining member 350 comprises a mesh filter 360 positioned above a basin 370. The mesh filter 360 is configured to drain any liquid material forming part of the thermal storage medium from the chamber 300 to the basin 370, as will be described.

The interior space 400 is defined between floor 120, front wall 150 and rear wall 160 of the container 100 and the top wall 220 and side walls 210a, 210b of the interior wall structure 200. The interior space 400 holds one or more temperature sensitive products for transport.

In this embodiment, a thermal storage medium in the form of ice slurry is injected into the chamber 300 via an external piping system (not shown). The ice slurry creates an igloo-like effect around interior space 400, thereby maintaining a generally uniform temperature within the interior space 400 for a period of time. As such, during shipping or storage operations within the period of time, any product placed within the interior space 400 will not spoil due to extreme high or low temperatures. Over time, as the ice slurry melts, any resultant liquid drains through the mesh filter 360 and into the basin 370. As desired, the liquid may be disposed of or recycled for future use. As will be appreciated, varying the composition of the thermal storage medium varies the temperature of the interior space 400.

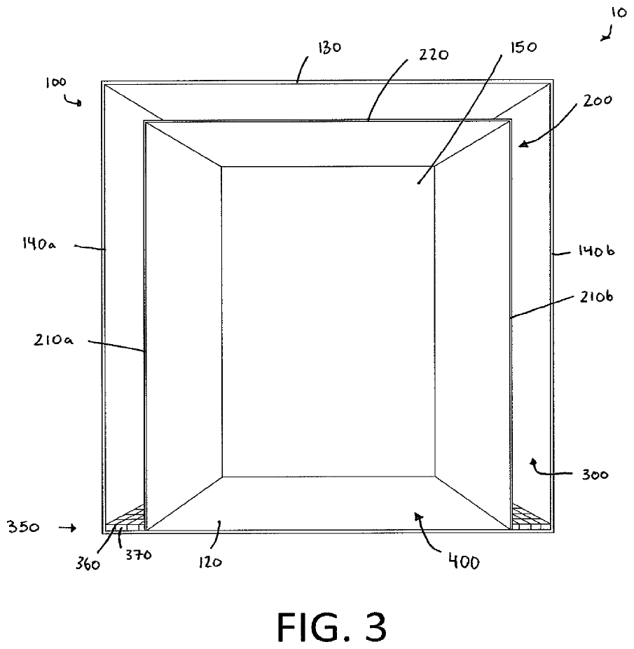

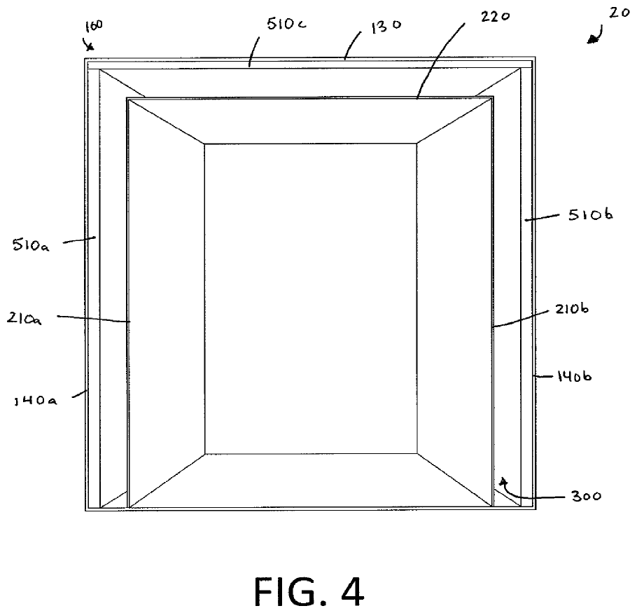

Turning now to FIG. 4, another embodiment of a container is shown and is identified by reference numeral 20. In this embodiment, like reference numerals will be used to indicate like components. As can be seen, the container 20 is similar to container 10 with the addition of an insulation layer 500. In this embodiment, the insulation layer 500 comprises three (3) vacuum insulated panels (VIP) 510a, 510b and 510c positioned interior of a respective one of the side walls 140a and 140b and ceiling 130 of the exterior wall structure 100. In this embodiment, the chamber 300 is defined between the VIPs 510a to 510c and the top wall 220 and side walls 210a, 210b of the interior wall structure 200. The container 20 may also comprise the draining member 350 shown in FIG. 3.

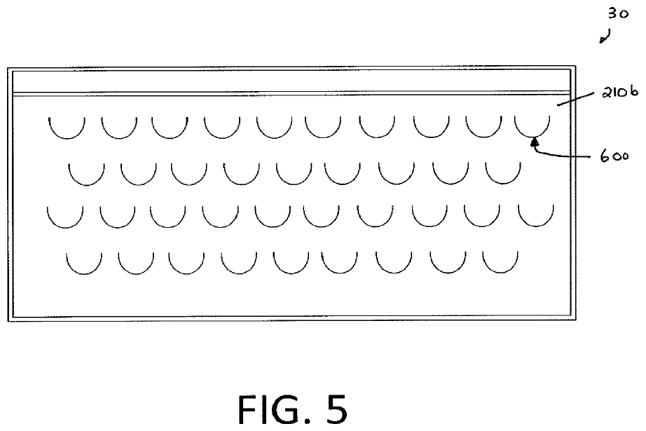

Turning now to FIG. 5, another embodiment of a container is shown and is identified by reference numeral 30. In this embodiment, like reference numerals will be used to indicate like components. As can be seen, container 30 is similar to container 10 with the exception of the side walls. As shown in FIG. 5, side wall 210b supports a plurality of collectors 600 which in this embodiment are generally U-shaped. The collectors 600 are dispersed about the exterior planar surface of side wall 210b and extend into the chamber 300. In this embodiment, the collectors 600 are made of a rigid material. The collectors 600 support the thermal storage medium contained within the chamber 300 to ensure large portions of the side walls 210a and 210b are not left without thermal storage medium. For example, in the event that the thermal storage medium is ice slurry, the collectors 600 support portions of the ice slurry as it melts. Container 30 may also comprise the draining member 350 shown in FIG. 3. It will be appreciated that the collectors 600 may additionally or alternatively be positioned on the interior planar surface of the side walls 140a and 140b of the exterior wall structure 100.

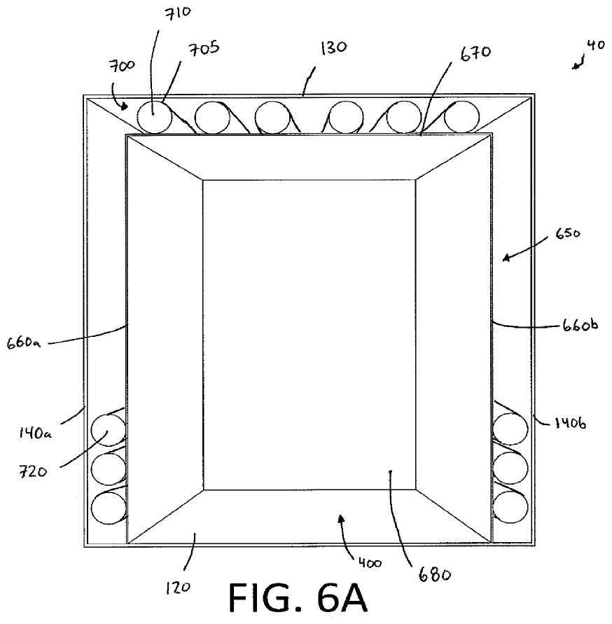

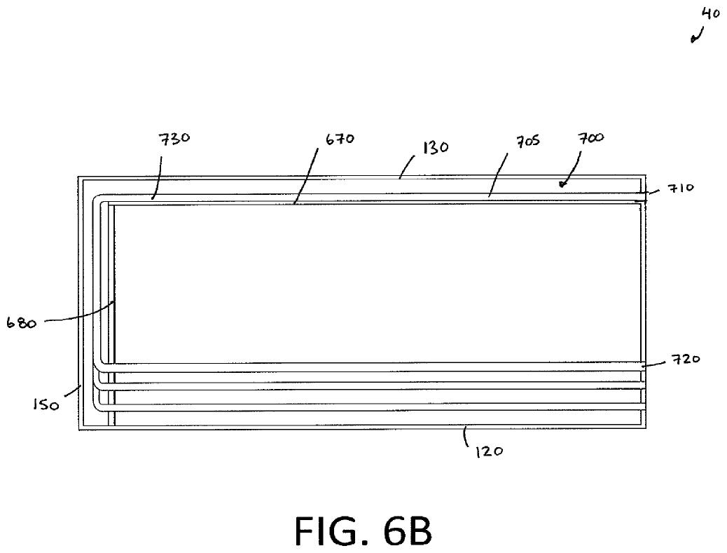

Turning now to FIGS. 6a and 6b, another embodiment of a container is shown and is identified by reference numeral 40. In this embodiment, like reference numerals will be used to indicate like components. Container 40 is generally similar to that of container 10, with the following exceptions. In this embodiment, interior wall structure 650 comprises side walls 660a and 660b, a top wall 670 and a front wall 680. Each of the side walls 660a and 660b is positioned in a substantially parallel-spaced relationship with respect to a respective side wall 140a and 140b of the exterior wall structure 100. The top wall 670 extends between the side walls 660a and 660b and is positioned in a substantially parallel-spaced relationship with respect to the ceiling 130 of the exterior wall structure 100. The front wall 680 extends front the top wall 670 to the floor 120 and is positioned in a substantially parallel-spaced relationship with respect to the front wall 150 of the exterior wall structure 100. The interior wall structure 650 is made of a generally rigid and thermally conductive material.

The thermal storage medium is held within a constricted space in the chamber 300. In this embodiment, the constricted space is defined by a piping system 700. The piping system 700 is thermally coupled to the interior wall structure 6500. The piping system 700 comprises a plurality of pipes 705, in this embodiment six (6), each of which comprises an inlet 710, an outlet 720 and a pipe body 730 extending therebetween. The inlet 710 is positioned adjacent to the rear wall 160 of the exterior wall structure 100. As shown in FIG. 6b, the pipe body 730 extends generally parallel to the ceiling 130 towards the front wall 150 of the exterior wall structure 100. The pipe body 730 bends at a right angle at a position adjacent to the front wall 150 and extends at an angle towards the floor 120 and towards one of the side walls 140a and 140b of the exterior wall structure 100. The pipe body 730 bends at a right angle at a position adjacent to the intersection of the front wall 150 and the floor 120. The pipe body 730 continues back towards rear wall 160 of the exterior wall structure 100 within the chamber 300. The pipe body 730 ends at the outlet 720 which is positioned adjacent to intersection of the floor 120 and the rear wall 160 of the exterior wall structure 100.

In this embodiment, a thermal storage medium in the form of ice slurry is pumped into the inlet 710 of each one of the pipes 705 via a pumping unit (not shown). The ice slurry is pumped until each pipe body 730 is full of ice slurry. As each of the pipes 705 is thermally coupled to the interior wall structure 650, thermal energy is exchanged therebetween. As the interior wall structure 650 surrounds the interior space 400, a generally uniform temperature is maintained within the interior space 400 for a period of time. During shipping or storage operations within the period of time, any product placed within the interior space 400 will not spoil due to extreme high or low temperatures. In this embodiment, the ice slurry contained in each of the pipes 705 may be removed by pumping air through the inlet 710, forcing the ice slurry out of the outlet 720. Alternatively, the pipes 705 may be readily refilled by pumping new ice slurry into the pipes 705 via the inlet 710, forcing old or melted ice slurry out of the pipes 705 via the outlet 710. The pipes 705 may also be drained using gravity. As will be appreciated, varying the composition of thermal storage medium varies the temperature of the interior space 400.

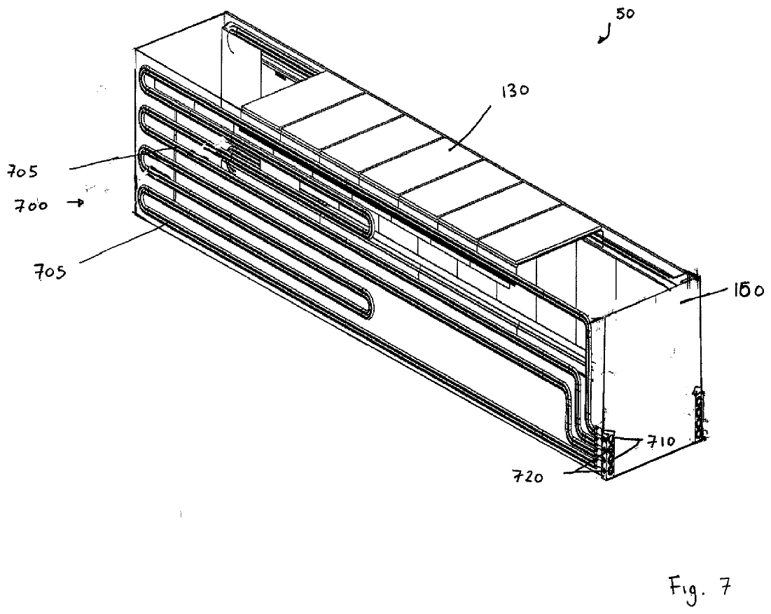

Turning now to FIG. 7, another embodiment of a container is shown and is generally identified by reference numeral 50. In this embodiment, like reference numerals will be used to indicate like components. As can be seen, container 50 is similar to container 40 with the exception that the piping system 700 comprises two (2) pipes 705. In this embodiment, the inlet 710 and outlet 720 of each of the pipes 705 extends through the rear wall 160 of the container 100 such that they are accessible from outside of the interior space 400. The pipe body 730 of each of the pipes 705 extends about the chamber 300 adjacent to one of the side walls 140a and 140b to define a serpentine channel configured to direct the ingress of thermal storage medium received via the inlet 710. During use the inlet 710 and outlet 720 of each pipe 705 are each sealed with a removable cap (not shown).

In this embodiment, a thermal storage medium in the form of ice slurry is pumped into the inlet 710 of each one of the pipes 705 via a pumping unit. The ice slurry travels around the serpentine channel defined by the pipe body 730. Once each pipe 705 is fully of ice slurry, the inlet 710 and 720 are each sealed with a removable cap. As each of the pipes 705 is thermally coupled to the interior wall structure 200, the pipes 705 transfer thermal energy to the interior wall structure 200 thereby maintaining a generally uniform temperature is within the interior space 400, as described above. The ice slurry contained in each of the pipes 705 may be removed or the pipes may be refilled with new ice slurry as described above.

In another embodiment, the constricted space may be defined by a removable conductive structure having a chamber defined therewith. In this embodiment, the chamber within the removable conductive structure may be filled with a thermal storage medium and then placed inside the container using a track system. In another embodiment, the removable conductive structure may have compartments defined therein to ensure thermal storage medium is dispersed throughout. In another embodiment, the removable conductive structure may be collapsible such that it can be collapsed when not in use.

Those skilled in the art will appreciate that conventional containers may be retro-fit to be a temperature controlled container such as that described in any of the above embodiments. To retro-fit a conventional container, interior wall structure, such as that described above, is installed in the conventional container such that the interior wall structure is in a parallel-spaced relationship with the wall structure of the conventional trailer, thereby defining a chamber. The chamber may then be filled with thermal storage medium in a manner described in any of the above embodiments.

Although in some embodiments above the side walls of the interior wall structure are described as being made of a rigid material, those skilled in the art will appreciate that the side walls of the interior wall structure may be made of a rigid, thermally conductive material.

In some embodiments above the system is described as utilizing an insulation layer. Those skilled in the art will appreciate that any of the above described embodiments may utilize an insulation layer.

Although in embodiments above the insulation layer is described of being made of a plurality of VIPs, those skilled in the art will appreciate that other types of insulation may be used.

Although in embodiments above the thermal storage medium is described as being ice slurry, those skilled in the art will appreciate that alternative types of thermal storage medium may be used. For example, in another embodiment, a heating liquid such as for example glycol may be used or a phase change material such as a paraffinic wax.

In another embodiment, an air gap may be defined intermediate the container side walls and ceiling and the interior wall structure (or intermediate the insulation layer and the interior wall structure) and a fan unit may be provided to circulate air that is heated/cooled by the thermal storage medium positioned within the chamber or contained within the piping system.

Although in embodiments above the collectors are described as being generally U-shaped, those skilled in the art that alternatives are available. For example, in another embodiment the collectors may be V-shaped or may be generally flat. Alternatively, the collectors may be obstacles in the form of circles, triangles, squares, diamonds, etc. In another embodiment, the collectors may be provided with a mesh bottom, such that any solid material forming part of the thermal storage medium will be retained by the collectors, and any liquid material forming part of the thermal storage medium will be drained through the mesh bottom.

Although in embodiments above the collectors are described as being made of a rigid material, those skilled in the art will appreciate that the collectors may be made of a rigid, thermally conductive material.

Although in embodiments above the rear wall is described as being provided with a door such as for example a swing-type trailer door or a roll-type trailer door, those skilled in the art will appreciate that alternative types of doors may be used. For example, in another embodiment the door may be provided with an insulation layer.

Although in embodiments above the system is described as comprising a draining member comprising a mesh filter positioned above a basin, those skilled in the art will appreciate that variations are available. For example, in an embodiment, the basin may comprise a draining opening configured to drain liquid out of the container. As will be appreciated, in this embodiment, the liquid may drain out of the container during travel. In another embodiment, the draining member may only comprise a basin, that is, the draining member may not have a mesh filter. In another embodiment, the basin may be positioned exterior of the container such that liquid may drain out of the container and into the basin.

Although embodiments have been described above with reference to the accompanying drawings, those of skill in the art will appreciate that variations and modifications may be made without departing from the scope thereof as defined by the appended claims.

What is claimed is:

1.-21. (canceled)

22. A temperature controlled cargo shipping container, comprising:
an exterior wall structure;
an interior wall structure positioned within the exterior wall structure, the interior wall structure at least partially defining an interior space within the shipping container configured to hold one or more products for shipping;
a chamber defined between the interior wall structure and exterior wall structure; and
a piping assembly extending generally throughout the chamber, the piping assembly configured to receive and retain a thermal storage medium injected therein from an external system prior to product shipping or storage operations and configured to be sealed during product shipping or storage operations so that the thermal storage medium provides a passive thermally insulative layer at least partially protecting the interior space.

23. The temperature controlled cargo shipping container of claim 22 wherein the interior wall structure is made of a thermally conductive material.

24. The temperature controlled cargo shipping container of claim 22 comprising a drain positioned at a bottom portion of the chamber.

25. The temperature controlled cargo shipping container of claim 24 wherein the drain comprises a basin for receiving a liquid portion of the thermal storage medium.

26. The temperature controlled cargo shipping container of claim 25 further comprising a filter configured to permit the liquid portion of the thermal storage medium to pass into the basin and to prevent a solid portion of the thermal storage medium from passing into the basin.

27. The temperature controlled cargo shipping container of claim 22 wherein the thermal storage medium is a cooling medium.

28. The temperature controlled cargo shipping container of claim 27 wherein the cooling medium is ice slurry.

29. The temperature controlled cargo shipping container of claim 22 wherein the thermal storage medium is a heating medium.

30. The temperature controlled cargo shipping container of claim 29 wherein the heating medium is glycol.

31. The temperature controlled cargo shipping container of claim 22 further comprising an insulation layer lining one or more interior surfaces of the exterior wall structure.

32. The temperature controlled cargo shipping container of claim 31 herein the insulation layer comprises vacuum insulated panels.

33. A method of retro-fitting a conventional cargo shipping container having an exterior wall structure with a passive cooling arrangement, the method comprising:
installing an interior wall structure within the conventional cargo shipping container, the interior wall structure positioned such that at least a portion of the interior wall structure is in a generally parallel-spaced relationship with at least a portion of the exterior wall structure, thereby defining a chamber between the exterior wall structure and the interior wall structure;
injecting a thermal storage medium into a piping assembly extending generally throughout the chamber using an external system prior to shipping or storage operations; and
sealing the piping assembly within the chamber so that the thermal storage medium provides a passive thermally insulative layer at least partially protecting a product receiving interior space defined at least partially by the interior wall structure during product shipping or storage operations.
